(19) United States
(12) Patent Application Publication
(10) Pub. No.: US 2011/0032531 A1
(43) Pub. Date: Feb. 10, 2011

(54) Static interferometry system and method

(76) Inventors: Denis Simeoni, Le Rouret (FR); Olivier Pigouche, Grasse (FR); Bruno Chetrite, Mandelieu (FR); Christian Buil, Castanet-Tolosan (FR)

Correspondence Address: STROOCK & STROOCK & LAVAN LLP, 180 MAIDEN LANE, NEW YORK, NY, 10038, US

(21) Appl. No.: 12/818,901

(22) Filed: Jun. 18, 2010

(30) Foreign Application Priority Data
Jun. 19, 2009 (FR) 0902994

(51) Int. Cl. G01J 3/45

(52) U.S. Cl. 356/455

(57) ABSTRACT

The invention pertains to a static interferometry system comprising two mirrors produced respectively by vertical assemblage (EH) and horizontal assemblage (EV) of a set of parallel plates of constant width, shifted along the optical axis so as to form stairs of variable optical path difference, the said two staircase mirrors (EH, EV) being disposed orthogonally so as to form, by optical superposition, a set of square facets engendering different optical path differences for the incident signal, and a detection device (DET) for detecting the set of optical path differences of the resulting interferogram. The system comprises, furthermore, means of continuous variation (LC) of the optical path difference during the acquisition of data by the detection device (DET), and sampling means (S, ACQL) for sampling the continuous optical path difference acquired while complying with the Nyquist criterion.

The invention pertains to a static interferometry system and method comprising two mirrors, for example for analysing a narrow spectrum in a wide spectral domain.

A conventional Michelson interferometer comprises two plane mirrors associated with a splitter so that an incident beam entering the interferometer produces a pair of split and parallel beams on exit from the interferometer exhibiting between them an optical path difference that can be varied by displacing one of the mirrors.

This interferometer makes it possible, inter alia, to determine the exact nature of a monochromatic radiation.

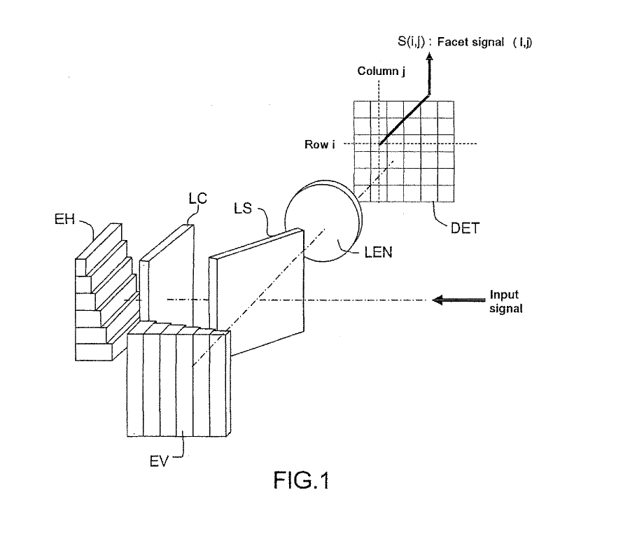

The document FR 2787186 (CENTRE NATIONAL D'ETUDES SPATIALES) pertains to a static interferometer using two mirrors EH and EV produced by assembling a set of plates of constant thickness. The plates are shifted along the optical axis so as to form stairs of variable optical path difference. The plates of the two mirrors are assembled orthogonally so as to constitute, by optical superposition of the two mirrors, a set of square facets with different optical path differences. The image of the two mirrors is conjugated, with the aid of a convergent lens LEN, with a detection device DET so as to carry out the simultaneous acquisition of the set of optical path differences of the interferogram. FIG. 1 schematically represents such a device. Such an interferometer provides, on the basis of one and the same incident beam, a plurality of pairs of exit beams, exhibiting fixed and distinct optical path differences.

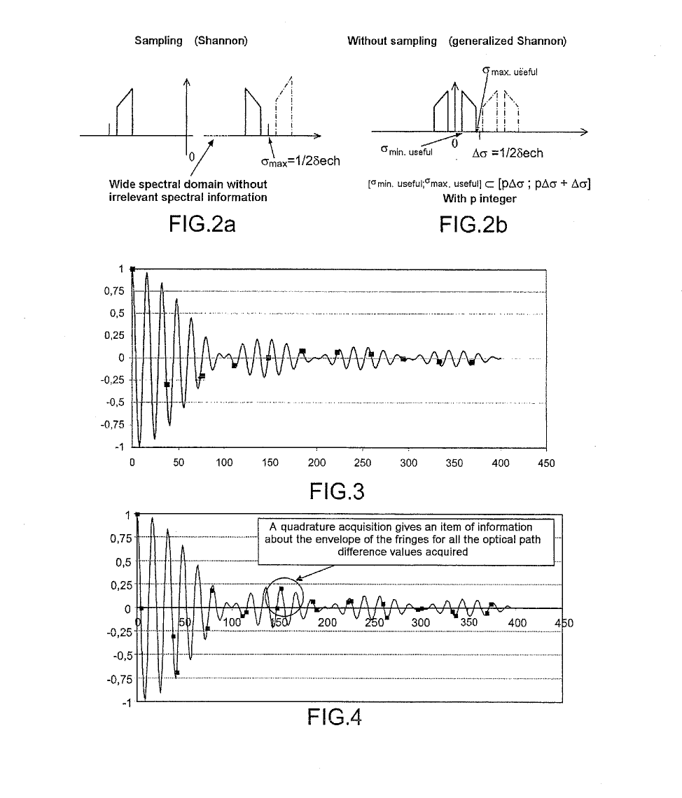

The principle of static interferometry is based on the generalized Shannon theorem which defines the sub-sampling conditions for an interferogram, which make it possible to obtain a reconstruction of the spectrum without overlap. The application of the generalized Shannon theorem is very effective when the observed spectral domain Δσₘₐₓ is very much smaller than the smallest wavelength σₘᵢₙ. In this case the number of samples to be acquired may be much reduced with respect to a conventional interferometric acquisition which complies with the conditions of Shannon's theorem. This is illustrated schematically in FIGS. 2a and 2b.

The principle of interferometry is to carry out the acquisition of a sub-sampled interferogram, as illustrated in FIG. 3.

It has been demonstrated by the Centre National d'Etudes Spatiales, that there is a significant gain in signal-to-noise ratio when two points in phase quadrature are acquired for each of the optical path differences, as illustrated in FIG. 4.

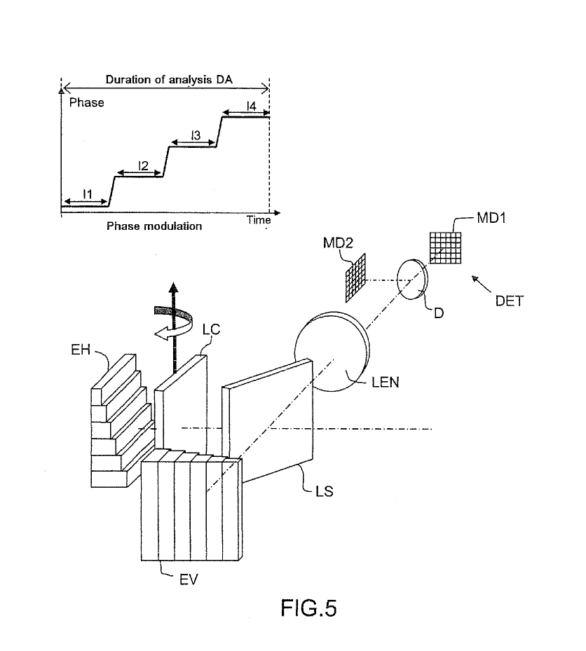

A known solution for acquiring data in phase quadrature, simultaneously in several spectral bands, is illustrated in FIG. 5. This solution consists in establishing, for the duration of analysis DA of the signal, four different phases for each optical path difference, and in acquiring the signal during the corresponding acquisition time I1, I2, I3, and I4. The phase variation is created by a moving element in the interferometer, such as a rotation of a compensator plate LC in the example of FIG. 5. Several bands may be obtained simultaneously by spectral splitting at the output of the interferometer. In the case of a system with two bands according to FIG. 5, the detection device DET comprises two detection device matrices MD1 and MD2 and a dichroic splitting element D.

The useful signal, or modulated part of the signal, is obtained by taking the difference between two samples of opposite phase. The signal-to-noise ratio of this difference is optimal if the two subtracted terms are exactly in phase opposition.

An appreciable improvement in the signal-to-noise ratio in the domain of the spectrum has been noted if two items of information in phase quadrature were provided per optical path difference. This improvement in the signal-to-noise ratio is due, on the one hand to a decrease in the regularization noise, the regularization process generating regularization noise, and on the other hand to a decrease in the noise amplification, the original noise at the level of the interferogram being amplified by the regularization process. The optimization of the signal-to-noise ratio therefore requires that the system provides two items of information, arising from the difference of the terms in phase opposition, in phase quadrature. This result is obtained by carrying out the acquisition of 4 phases spaced regularly apart.

For a band centred at the wavelength λ₁, the modulation is obtained by subtracting the signals in phase opposition 1 and 3 and then 2 and 4:

$$\{ \begin{matrix}Phase 1 - Phase 3 = 2 π ( Δ1 - Δ3 ) / {λ}_{1} = π \\ Phase 2 - Phase 4 = 2 π ( Δ2 - Δ4 ) / {λ}_{1} = π\end{matrix}$$

thus involving a mismatch in optical path differences

Δ=Δ1−Δ3=Δ2−Δ4=λ₁/2

The items of information arising from the two subtractions are in phase quadrature if the following conditions are realized:

Phase 1−Phase 2=2π(Δ1−Δ2)/λ₁=π2

thus imposing a mismatch in optical path differences Δ1−Δ2=₁/4

This principle therefore imposes four phase states separated by π/2, respectively four states of optical path differences separated by λ₁/4. It is noted that this condition can only be complied with for the wavelength λ₁.

The adaptation to a second wavelength λ₂, when incorporating another spectral band, makes it necessary to waive one of the two previously established constraints. For example, if the wavelength of the 2nd band λ₂ is almost double the wavelength of the first band λ₂, the modulation is obtained by differencing phases 1 and 2 and then 3 and 4, the resulting subtraction is not in phase opposition:

$$\{ \begin{matrix}Phase 1 - Phase 2 = 2 π ( Δ1 - Δ2 ) / {λ}_{2} = π / 2 {λ}_{1} / {λ}_{2} \approx π / 4 \\ Phase 3 - Phase 4 = 2 π ( Δ2 - Δ4 ) / {λ}_{1} = π / 2 {λ}_{1} / {λ}_{2} \approx π / 4\end{matrix}$$

The two items of information arising from the two subtractions remain in phase quadrature if the following relation is complied with:

$$\{ \begin{matrix}Phase 1 - Phase 3 = 2 π ( Δ1 - Δ3 ) / {λ}_{1} = 3 π / 2 \\ Phase 2 - Phase 4 = 2 π ( Δ2 - Δ4 ) / {λ}_{1} = 3 π / 2\end{matrix}$$

At the wavelength λ₂ the modulation is obtained by differencing phases 1 and 3 and then 2 and 4

$$\{ \begin{matrix}Phase 1 - Phase 3 = 2 π ( Δ1 - Δ3 ) / {λ}_{2} = 3 π / 2 {λ}_{1} / {λ}_{2} \approx 3 π / 4 \\ Phase 2 - Phase 4 = 2 π ( Δ2 - Δ4 ) / λ2 = 3 π / 2 {λ}_{1} / {λ}_{2} \approx 3 π / 4\end{matrix}$$

The two items of information arising from the two subtractions remain in phase quadrature:

Phase1−Phase2=2π(Δ₁−Δ₂)/λ₂≈π/2

It is noted that the principle of acquisition with four phases is not perfectly tailored for a system with two spectral bands.

When two spectral bands are acquired (exhibiting a ratio of two between the central wavelengths in the example above), the phase opposition condition is not complied with for the two bands (3π/4 instead of π at the wavelength λ₂ in the above example), thereby resulting in a degradation of the signal-to-noise ratio of the mistuned band. This is a significant constraint in adapting the principle to a simultaneous analysis of several bands.

The principle illustrated in FIG. 5 presents drawbacks. It makes it necessary to introduce a moving element into the core of the interferometer which must be very stable. The acquisition of the four phases within the analysis duration requires durations of changes of phases which must be small with respect to the durations of acquisition, and the phases are optimized from the point of view of the signal-to-noise ratio for just one of the spectral bands acquired.

A problem posed is therefore the obtaining of two items of information in phase quadrature, for each of the optical path differences, under optimal conditions of signal-to-noise ratio, doing so for several spectral bands acquired simultaneously, at the same positions.

It would also be beneficial to carry out the acquisition of such items of information in phase quadrature, with a static interferometer, without implementing phase modulation so as to avoid introducing a moving element into the core of the interferometer.

Carrying out acquisition in phase opposition or phase quadrature based on increasing the number of stairs per mirror and very precise positioning of the stairs of the mirrors would require a stair positioning precision of much less than a micron, this being difficult to reconcile, or indeed incompatible with the production constraints when making the mirrors of the interferometer, for which the current precision is of the order of a few microns.

An aim of the invention is to alleviate the various problems cited above.

There is proposed, according to one aspect of the invention, a static interferometry system comprising two mirrors produced respectively by vertical assemblage and horizontal assemblage of a set of parallel plates of constant width, shifted along the optical axis so as to form stairs of variable optical path difference, the said two staircase mirrors being disposed orthogonally so as to form, by optical superposition, a set of square facets engendering different optical path differences for the incident signal. The system comprises, furthermore, means of continuous variation of the optical path difference, a device for detecting the set of optical path differences of the resulting interferogram, and means of continuous variation of the optical path difference, and sampling means for sampling the said continuous optical path difference while complying with the Nyquist criterion.

Such a system makes it possible to obtain a continuum of phases per facet of optical path difference, on the basis of which may be obtained in an optimal manner the modulation amplitude for two points in phase quadrature, for various spectral bands acquired simultaneously.

According to one embodiment, the said means of continuous variation are adapted for performing a phase modulation with dynamic continuous movement, so that the phase of the signal varies substantially linearly as a function of the acquisition time taken by the said detection device to acquire the optical path difference and the sampling means are adapted for sampling the optical path difference at constant interval through a signal arising from a laser source.

Thus, the variation in optical path difference may be carried out in a continuous and linear manner in the course of the analysis time. The rate of variation of optical path difference is proportional to the ratio of the variation in optical path difference to be acquired to the available scene analysis time. It is recommended that an optical path difference corresponding to at least one wavelength of the spectral band which exhibits the largest wavelength be acquired.

In the course of the duration of analysis, the phases are acquired successively, without loss of time between two acquisitions other than that necessary for the detection system to string two acquisitions together. Such a system makes it possible to acquire a phase set without the analysis time and therefore the effectiveness of the system being limited by the phase modulation device with dynamic continuous movement.

For example, the said means of continuous variation comprise a compensator plate and means for rotating the said compensator plate. The angle of rotation depends on the thickness of the compensator plate and the optical path difference to be created.

This embodiment makes it possible to introduce a variation in optical path difference without modifying the design of the interferometer other than the rotating of the compensator plate.

For example, the said means of continuous variation comprise a compensator plate exhibiting a bevel and means for translating the said compensator plate. The translation distance to be applied is adapted as a function of the value of the bevel of the compensator plate.

Reduced linear displacements are thus sufficient, dependent on the angle of bevel of the compensator plate.

For example, the said means of continuous variation comprise two compensator plates, and means for oppositely rotating the said compensator plates.

The opposite rotation of the two compensator plates allows optical compensation and limitation of the exported forces of the system for actuating the two plates.

For example, the said means of continuous variation comprise two compensator plates exhibiting opposite bevels and means for oppositely translating the said compensator plates.

The opposite bevels of the two compensator plates allow optical compensation of the bevel effect on the quality of the interferograms acquired, and the opposite translation of the two compensator plates avoids the propagation of the forces for actuating the two compensator plates outside of the system for actuating the compensator plates. The exported forces are thus compensated.

For example, the said means of continuous variation comprise means for translating at least one of the said staircase mirrors.

The translation of at least one of the said staircase mirrors is carried out over very reduced stretches, of the order of a wavelength. This embodiment makes it possible to introduce a variation in optical path difference without modifying the design of the interferometer other than the translating of one of the said staircase mirrors.

In one embodiment, the said sampling means are adapted for sampling the optical path difference at constant optical path difference interval through a signal arising from the said laser source.

The sampling at constant optical path difference interval reduces the effects of variations in rate of the optical path difference on the quality of the interferograms acquired.

In another embodiment, the said sampling means are adapted for sampling the optical path difference at constant time interval.

The sampling of the optical path difference at constant time interval, is the conventional mode of sampling of detection device matrices. The acquisition time per sample is constant.

According to another embodiment, the said means of continuous variation comprise an inclination of one of the said staircase mirrors creating for each facet optical path difference a set of static fringes in the plane of the said detection device.

The continuous variation in optical path difference is carried out without introducing a moving element into the interferometer. The interferometer is then perfectly static and stable.

The said inclination, expressed in radians, can be substantially equal to the value defined by the following expression:

(λ/2)/(N×WdthStr)

in which:
λ represents the central wavelength of the spectral band of the incident signal, in m;
WdthStr represents the width of a stair, in m; and
N represents the number of fringes desired per facet.

There is also proposed, according to another aspect of the invention, a static interferometry method using two mirrors produced respectively by vertical assemblage and horizontal assemblage of a set of parallel plates of constant width, shifted along the optical axis so as to form stairs of variable optical path difference, the said two staircase mirrors being disposed orthogonally so as to form, by optical superposition, a set of square facets engendering different optical path differences for the incident signal, and a device for detecting the set of optical path differences of the resulting interferogram. The optical path difference is varied continuously during the acquisition of data by the detection device, and the continuous optical path difference acquired is sampled while complying with the Nyquist criterion.

The invention will be better understood on studying a few embodiments described by way of wholly non-limiting examples and illustrated by the appended drawings in which:

FIGS. 1 to 5 illustrate the prior art;

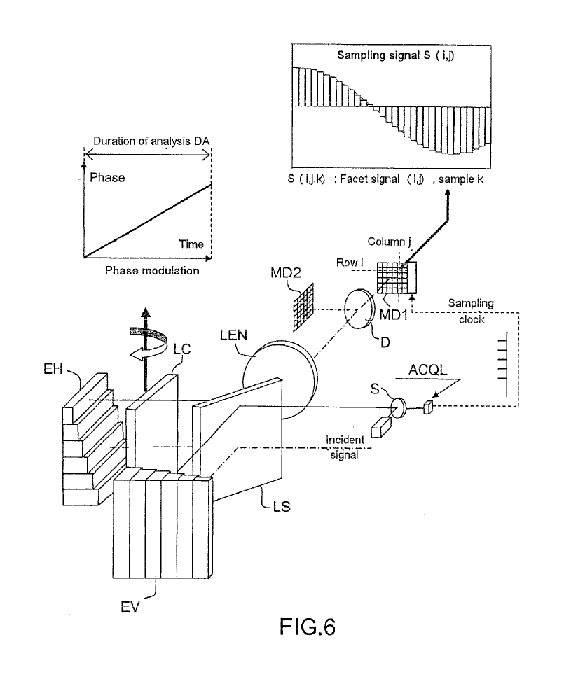

FIG. 6 is a schematic diagram of an embodiment of a system according to one aspect of the invention, with dynamic continuous phase modulation;

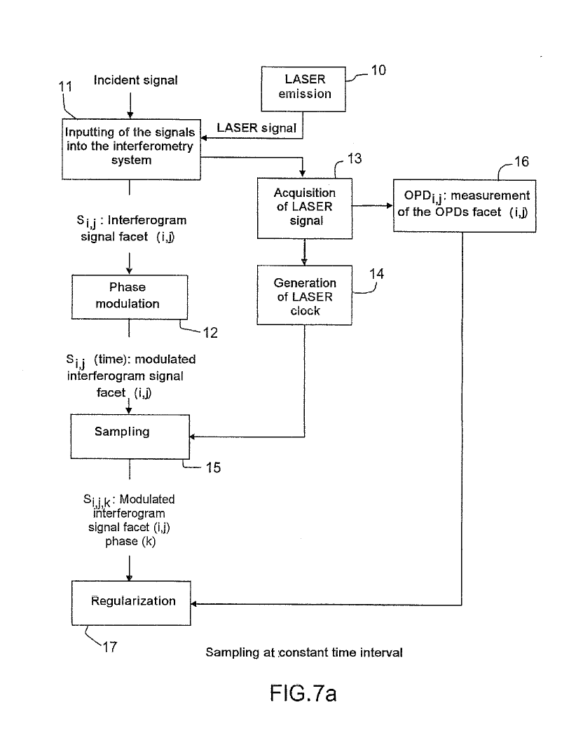

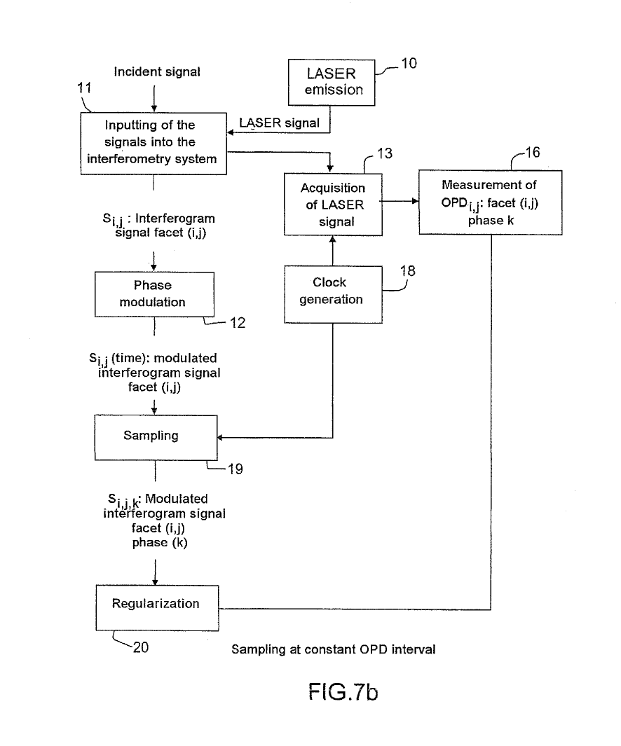

FIG. 7a illustrates the operation of an embodiment of a system of FIG. 6 according to one aspect of the invention;

FIG. 7b illustrates the operation of an embodiment of a system of FIG. 6 according to another aspect of the invention;

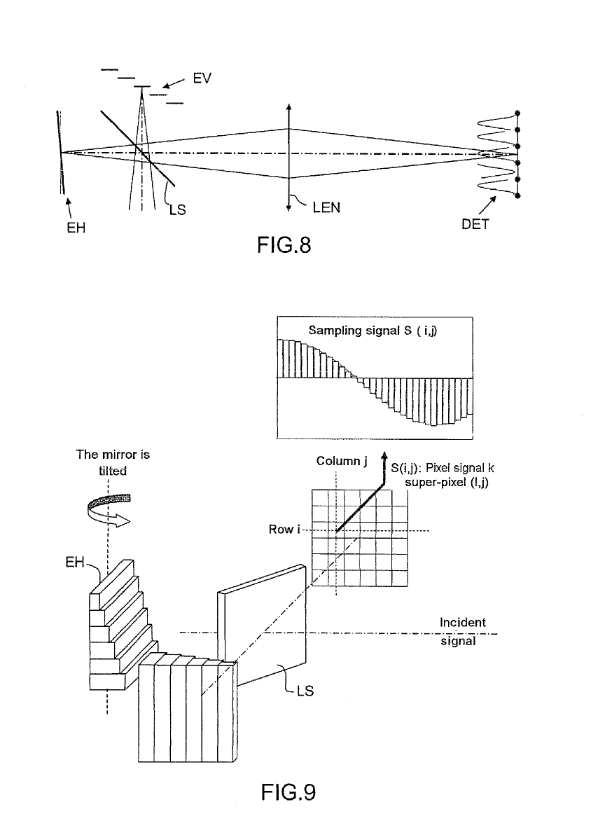

FIGS. 8, 9 and 10 illustrate a system according to one aspect of the invention, with static continuous phase modulation; and

FIG. 11 demonstrates advantages of the invention.

In the various figures, the elements having identical references are identical.

As illustrated in FIG. 6, a static interferometry system comprises two mirrors EH and EV produced respectively by vertical assemblage and horizontal assemblage of a set of parallel plates of constant width, shifted along the optical axis so as to form stairs of variable optical path difference. The two mirrors EH and EV are disposed orthogonally, and form, by optical superposition, a set of square facets engendering different optical path differences for the incident signal. The system also comprises a detection device DET for detecting the set of optical path differences of the resulting interferogram, comprising two detector matrices MD1 and MD2 and a dichroic splitting element D.

The system also comprises means of continuous variation, for example a compensator plate LC, for continuously varying the optical path difference during the acquisition of data by the detection device MD1 and MD2, and sampling means S and ACQL. The means of continuous variation vary, preferably, substantially linearly the phase of the signal in the course of the analysis time DA.

The means of continuous variation represented in FIG. 6 comprise a compensator plate LC and means, not represented in FIG. 6, for rotating the said compensator plate. As a variant, the means of continuous variation could, for example, comprise two compensator plates and means for oppositely rotating the said compensator plates. As a variant, the means of continuous variation could, for example, comprise a compensator plate exhibiting a bevel and means for translating the said compensator plate, or two compensator plates exhibiting opposite bevels and means for oppositely translating the said compensator plates, or comprise means for translating at least one of the two staircase mirrors EH, EV.

FIG. 6 illustrates a realization of a continuous variation of the optical path differences by using a mechanism of phase with continuous movement sampled at constant optical path difference interval by a clock timing signal in phase with the variations in optical path difference. The clock is designed on the basis of the optical beam from a laser source, injected into the interferometer. This implementation, called continuous phase modulation with sampling at constant optical path difference interval, is illustrated in FIG. 7a.

In FIG. 7a, an incident signal or atmospheric signal, and a laser signal emitted by a laser source (step 10), are received by an interferometry system according to one aspect of the invention (step 11). The system acquires a set of signals S_{i,j} corresponding to the respective interferograms of the facets with row index i and column index j. A phase modulation (step 12) is applied to each of the signals S_{i,j}. In parallel, an acquisition of the laser signal is performed (step 13), on the basis of which a clock generation is performed (step 14) allowing a sampling (step 15) at constant optical path difference interval of the signals S_{i,j} corresponding to the respective modulated interferograms of the facets with row index i and column index j. Signals S_{i,j,k} are obtained, corresponding to the respective modulated interferograms of the facets with row index i and column index j and phase index k (sample k). As a variant, the laser signal can also make it possible to measure the optical path differences OPD_{i,j} of the set of facets with indices i,j (step 16) allowing a regularization (step 17) in which the irregularity in the optical path difference sampling induced by the construction of the staircase mirrors is corrected, the regularity of which on the scale of a nanometre is limited.

FIG. 7b presents a variant, with continuous phase modulation with sampling at constant optical path difference interval, which corresponds to a sampling at constant time interval. In FIG. 7b, an incident signal or atmospheric signal, and a laser signal emitted by a laser source (step 10), are received by an interferometry system according to one aspect of the invention (step 11). The system acquires a set of signals S_{i,j} corresponding to the respective interferograms of the facets with row index i and column index j. A phase modulation (step 12) is applied to each of the signals S_{i,j}. In parallel, an acquisition of the laser signal is performed (step 13). The sampling of the laser signal is triggered simultaneously with that of the interferogram signal by a timing signal emitted by a common clock (step 18). The laser signal is used to measure the variation in optical path difference (step 16), of each sample acquired (sample k). The clock (step 18) triggers a sampling (step 19) of the signals S_{i,j} corresponding to the respective modulated interferograms of the facets with row index i and column index j. Signals S_{i,j,k} are obtained, corresponding to the respective modulated interferograms of the facets with row index i and column index j and phase index k (sample k). The laser signal makes it possible to measure optical path differences OPD_{i,j} of the set of facets with indices i,j (step 16) for each phase k. Thus, a regularization (step 20) makes it possible to go from a sampling at constant time interval to a sampling at constant optical path difference interval, and to correct the irregularity of the optical path difference sampling (step 19) induced by the construction of the staircase mirrors, the regularity of which on the scale of a nanometre is limited.

In FIG. 8 is represented, as a variant, an interferometry system according to one aspect of the invention, in which the means of continuous variation comprise an inclination or tilt of one of the said staircase mirrors creating for each facet optical path difference a set of static fringes in the plane of the said detection device. In FIG. 8, the inclination is carried out on the mirror with horizontal stairs EH, only one of which is represented for reasons of clarity of FIG. 8, but as a variant, the inclination may be carried out on the mirror with vertical stairs EV, or on both mirrors EV and EH. A convergent lens LEN is represented in FIG. 8.

The system of fringes takes, in the plane of the detection device DET, the form of a modulation along a direction (row axis) per optical path difference facet. This modulation is sampled through the set of pixels constituting the super-pixel imaged with the facet. The modulation of the signal created by the phase variation is sampled while complying with the Nyquist criterion, a number N of samples is acquired per Optical Path Difference facet.

The variation in optical path difference is, in this embodiment, carried out through an inclination of the mirror with horizontal stairs EH so as to create, on each facet, an air wedge engendering a system of fringes in the plane of the detection device DET. The air wedge is adjusted to obtain typically one or more fringes per facet. It is recommended that at least one fringe be acquired in the case of the spectral band which exhibits the largest central wavelength. The inclination of one of the mirrors of the interferometry system creates an air wedge. The image of the air wedge in the plane of the detection device DET is at the origin of a system of fringes per optical path difference facet, such as illustrated in FIG. 9.

The inclination, expressed in radians, is substantially equal to the value defined by the following expression:

(λ/2)/(N×WdthStr)

in which
λ represents the central wavelength of the spectral band of the incident signal, in m;
WdthStr represents the width of a stair, in m; and
N represents the number of fringes desired per facet.

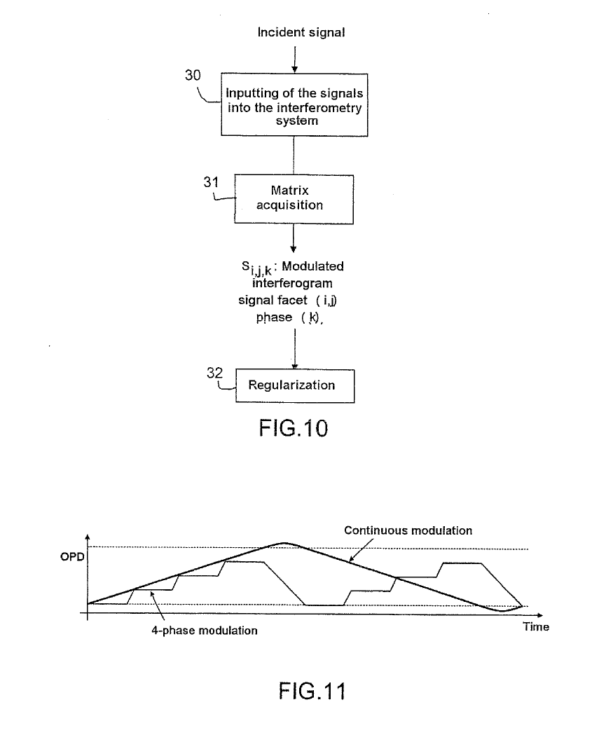

As illustrated in FIG. 10, the incident signal or atmospheric signal is received (step 30) by an interferometry system according to one aspect of the invention. During an acquisition (step 31), the set of signals S(i,j,k) corresponding to the Optical Path Differences OPD_{i,j} and to the phases k are acquired simultaneously. This embodiment does not require any laser source if the interferometric device is sufficiently stable to allow a regularization (step 32) on the basis of a measurement of optical path difference before the device is put into operation.

Whichever embodiment cited previously is implemented, it is possible to apply the data processing which follows.

The data processing proposed allows, for any number of samples N acquired greater than 4, the reconstruction of two items of information in phase quadrature (π/2 out of phase) per optical path difference, as advocated according to the explanations which follow.
Let us consider the vectors with N components Vcos(k) and Vsin(k) of the normalized cosine and normalized sine:

$${\vec{V}}_{cos} ( k ) = \frac{1}{{P}_{cos}} cos ( 2 π N ( k - 1 ) / K )$$

$${\vec{V}}_{sin} ( k ) = \frac{1}{{P}_{sin}} sin ( 2 π N ( k - 1 ) / K )$$

In which:
N represents the number of fringes acquired per optical path difference;
K represents the number of samples acquired on the N fringes; and
P_{cos} and Pₛᵢₙ represent normalizing coefficients.
The above two discrete Vectors are practically orthogonal, or, stated otherwise of zero scalar product, since the value of the integral of the function sine(x).cosine(x) over one or more periods is zero.

$$\frac{1}{{P}_{cos}} \frac{1}{{P}_{sin}} {\sum }_{k = 1}^{K} ( 2 π N ( k - 1 ) / K ) \times sin ( 2 π N ( k - 1 ) / K ) \approx 0$$

The scalar product of the vector S_{i,j,k} (modulated interferogram signal of the facet with indices i,j and with phase index k) and of the vectors V_{cos} and Vₛᵢₙ provides, for a given facet with indices i,j the following two coefficients:

$${a}_{1} ( i , j ) = \frac{1}{{P}_{cos}} {\sum }_{k = 1}^{N} {S}_{m} ( i , j , k ) cos ( 2 π N ( k - 1 ) / K )$$

$${a}_{2} ( i , j ) = \frac{1}{{P}_{sin}} {\sum }_{k = 1}^{N} {S}_{m} ( i , j , k ) sin ( 2 π N ( k - 1 ) / K )$$

in which:
S(i,j,k) represents the signal of the facet of Optical Path Differences OPD_{i,j} and of phase k

The two coefficients aᵢ(i,j) and a₂(i,j) obtained per facet (i,j) are the result of a linear combination with constant coefficients of the K initial interferograms per facet (i,j). This processing is equivalent to a filtering and a compression of the starting information. Two items of information in quadrature are obtained per optical path difference facet.

The situation is then comparable to that of the four-phase modulation for the number of points and their respective phase shift.
There is, however, an a priori difference with the four-phase acquisition for which the pairwise difference of signals makes it possible to eliminate the base line and the continuous (i.e. unmodulated) component.
It is possible to obtain this elimination by arranging for the algebraic sum of the components of each of the two vectors V_{cos}(k) and Vₛᵢₙ(k) to be zero, this being possible by adapting the number of points K or by arbitrarily forcing the last component of each vector so that the sum of the components is actually zero.
The latter condition may be written:

$${\vec{V}}_{cos} ( N ) = - {\sum }_{k = 1}^{N - 1} {\vec{V}}_{cos} ( k )$$

$${\vec{V}}_{sin} ( N ) = - {\sum }_{k = 1}^{N - 1} {\vec{V}}_{sin} ( k )$$

Under continuous modulation, the step-by-step displacement, or “step and dwell” displacement as it is known, of a four-phase acquisition is replaced with a continuous displacement of the payload in the course of the analysis phase.

As represented in FIG. 11, for a continuous modulation, the motion is a rectified sinusoid with a period typically of the order of 500 ms, and the slaving passband is of the order of 50 Hz. While in the case of a four-phase acquisition, the rise edge time is typically of the order of 5 ms, thus requiring a slaving passband of the order of 1 kHz. The ratio of the passbands, of the order of 20, is a considerable advantage of continuous phase modulation, in particular when the mass of the optical payload (greater than a kg) generates mechanical modes in the domain of the passband of the four-phase acquisition.

In four-phase modulation, the coupling between the mechanical modes and the control law for the mechanism results in a significant risk of the presence of micro-vibrations which results in a potential loss of control of the positioning of the payload and the generation of forces exported towards the interface. Under continuous modulation, this drawback is eradicated by the low slaving passband.

The presence of a laser source due to the requirement for a reference clock (devised on the basis of the detection of the zero-crossing of the interference fringes of the laser beam) used to trigger the sampling of the interferograms at constant OPD, makes it possible to obtain very accurate knowledge of the optical path differences (of the order of a nanometre).

In the case of the inclination of one of the two mirrors of the interferometry system, to create a system of fringes regularly sampled at N phase values, it is possible to carry out an acquisition in phase quadrature without imposing severe tolerances on the inclination of the mirrors.

By comparison with a four-phase or dynamic modulation concept, static continuous modulation makes it possible to eliminate a complex mechanism, exhibiting significant development risks and causing considerable extra cost that may reach several million euros.

By comparison with a conventional static concept without phase modulation, the invention allows the same advantages as quadrature modulation, since it amounts thereto. The continuous-modulation static principle does indeed make it possible to obtain for each facet a pair of points in quadrature (by a static means) and thus to obtain a gain by a factor of root two in the specification in terms of signal-to-noise ratio requirement, the reduction by a factor of two in the requirement in terms of number of stairs, and involves a dimensioning of the system identical to that carried out under quadrature phase modulation. Furthermore, just like quadrature modulation, the invention makes it possible to eliminate the step, critical in static mode, of eliminating the base line, since the modulation is extracted from the signal by the application of coefficients whose sum is equal to zero. The base line (constant part) is eliminated. The invention also makes it possible to decrease the sensitivity to non-uniformities of the detection device, since the modulation is extracted from the signal by the application of coefficients, thereby representing a step of (spatial) filtering of the signals. This filtering decreases the impact of the non-uniformities of response of the detection device. Finally, the invention facilitates the equalization process, since the latter is facilitated by the spatial filtering which greatly reduces the dependence in relation to the non-uniformities at low frequencies. Notably a measurement of the inter-pixel variations in response based on black body observation is conceivable on the interferogram (away from the central fringe).

1. Static interferometry system comprising two mirrors produced respectively by vertical assemblage (EH) and horizontal assemblage (EV) of a set of parallel plates of constant width, shifted along the optical axis so as to form stairs of variable optical path difference, the said two staircase mirrors (EH, EV) being disposed orthogonally so as to form, by optical superposition, a set of square facets engendering different optical path differences for the incident signal, and a detection device (DET) for detecting the set of optical path differences of the resulting interferogram, characterized in that it comprises, furthermore, means of continuous variation (LC) of the optical path difference, and sampling means (S, ACQL) for sampling the continuous optical path difference acquired while complying with the Nyquist criterion.

2. System according to claim 1, in which the said means of continuous variation are adapted for performing a phase modulation with dynamic continuous movement, so that the phase of the signal varies substantially linearly as a function of the acquisition time taken by the said detection device to acquire the optical path difference, and the sampling means are adapted for sampling the optical path difference at constant interval through a signal arising from a laser source.

3. System according to claim 2, in which the said means of continuous variation comprise a compensator plate (LC) and means for rotating the said compensator plate.

4. System according to claim 2, in which the said means of continuos variation comprise a compensator plate exhibiting a bevel and means for translating the said compensator plate.

5. System according to claim 2, in which the said means of continuous variation comprise two compensator plates, and means for oppositely rotating the said compensator plates.

6. System according to claim 2, in which the said means of continuous variation comprise two compensator plates exhibiting opposite bevels and means for oppositely translating the said compensator plates.

7. System according to claim 2, in which the said means of continuous variation comprise means for translating at least one of the said staircase mirrors (EH, EV).

8. System according to one of claims 2 to 7, in which the said sampling means are adapted for sampling the optical path difference at constant optical path difference interval through a signal arising from the said laser source.

9. System according to one of claims 2 to 7, in which the said sampling means are adapted for sampling the optical path difference at constant time interval.

10. System according to claim 1, in which the said means of continuous variation comprise an inclination of one of the said staircase mirrors (EH, EV) creating for each facet optical path difference a set of static fringes in the plane of the said detection device (DET).

11. System according to claim 10, in which the said inclination, expressed in radians, is substantially equal to the value defined by the following expression:
(λ/2)/(N×WdthStr)
in which
λ represents the central wavelength of the spectral band of the incident signal, in m;
WdthStr represents the width of a stair, in m; and
N represents the number of fringes desired per facet.

12. Static interferometry method using two mirrors produced respectively by vertical assemblage (EV) and horizontal assemblage (EH) of a set of parallel plates of constant width, shifted along the optical axis so as to form stairs of variable optical path difference, the said two staircase mirrors being disposed orthogonally so as to form, by optical superposition, a set of square facets engendering different optical path differences for the incident signal, and a detection device (DET) for detecting the set of optical path differences of the resulting interferogram, characterized in that the optical path difference is varied continuously during the acquisition of data by the detection device, and the continuous optical path difference acquired is sampled while complying with the Nyquist criterion.
